(19) United States
(12) Patent Application Publication
(10) Pub. No.: US 2013/0010113 A1
(43) Pub. Date: Jan. 10, 2013

(54) TRAFFIC SIGN INFORMING SYSTEM AND METHOD

(75) Inventors: Hou-Hsien LEE, New Taipei (TW); Chang-Jung LEE, New Taipei (TW); Chih-Ping LO, New Taipei (TW)

(73) Assignee: HON HAI PRECISION INDUSTRY CO., LTD., New Taipei (TW)

(21) Appl. No.: 13/217,148

(22) Filed: Aug. 24, 2011

(30) Foreign Application Priority Data
Jul. 6, 2011 (TW) 100123759

(51) Int. Cl. H04N 7/18

(52) U.S. Cl. 348/148; 348/E07.085

(57) ABSTRACT

A traffic sign informing method includes: capturing images in front of a car by a camera. Scanning the image captured by the camera to detect and determine whether or not there is a traffic sign in the image. Reading the driver-information offered by the sign when the presence of a traffic sign in the image has been determined. Informing the driver about the traffic sign.

### BACKGROUND

1. Technical Field

The present disclosure relates to an informing system and an informing method for traffic signs.

2. Description of Related Art

On some special areas, traffic signs are set on both sides of a road to give drivers information. However, sometimes the driver may not see the traffic signs, creating potential danger.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a schematic diagram of an exemplary embodiment of a traffic sign informing system used in a car.

FIG. 2 is a block diagram of the informing system of FIG. 1.

FIG. 3 is a flowchart of an exemplary embodiment of a traffic sign informing method.

### DETAILED DESCRIPTION

The disclosure, including the accompanying drawings, is illustrated by way of examples and not by way of limitation. It should be noted that references to “an” or “one” embodiment in this disclosure are not necessarily to the same embodiment, and such references mean at least one.

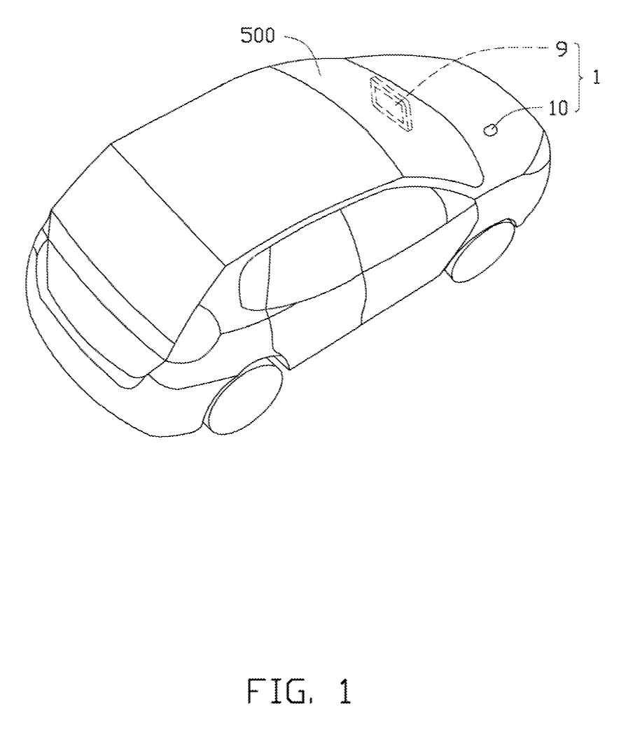

Referring to FIG. 1, an exemplary embodiment of a traffic sign informing system 1 is used in a car 500. The informing system 1 includes a host computer 9 and a camera 10. The camera 10 captures images around the car 500. The host computer 9 processes the images to determine whether there is one or more traffic signs in front of the car 500. When a traffic sign is in front of the car 500, the host computer 9 further informs the driver.

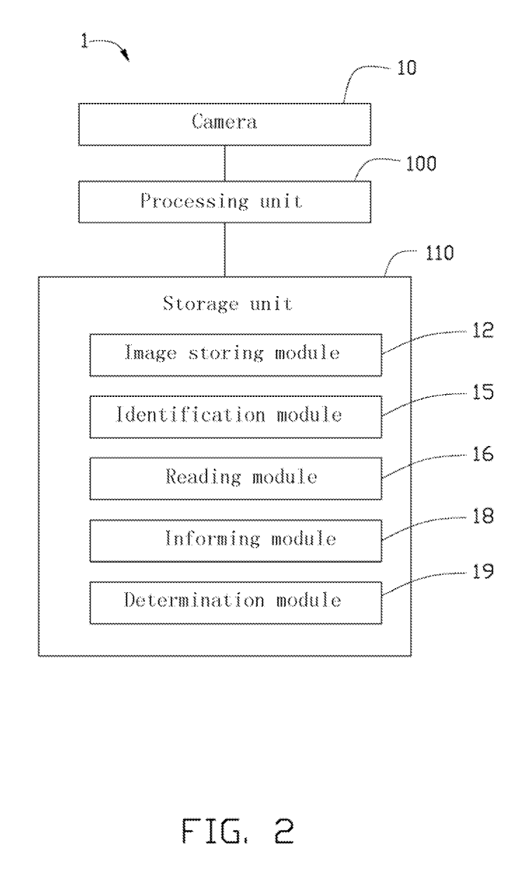

Referring also to FIG. 2, the host computer 9 includes a processing unit 100 connected to the camera 10, and a storage unit 110 connected to the processing unit 100. The storage unit 110 includes an image storing module 12, an identification module 15, a reading module 16, an informing module 18, and a determination module 19, which may include computer code to be executed by the processing unit 100.

The image storing module 12 stores a plurality of images of different traffic signs, and the information given by each traffic sign.

The camera 10 is mounted at the front of the car 500 to capture an image of the scene in front of the car 500. In other embodiments, the camera 10 can be mounted in another position on the car 500 to capture an image of the scene in front of the car 500. Moreover, the informing system 1 can include more than one camera.

The identification module 15 detects the images captured by the camera 10 to determine whether there is a traffic sign or signs in any of the images. In the embodiment, the identification module 15 compares each of the images captured by the camera 10 with the images stored in the image storing module 12 to determine whether or not there is a traffic sign. The identification module 15 may determine the presence of a traffic sign in the image.

The reading module 16 reads the warning or prohibition or other information from a traffic sign in the image. The informing module 18 informs the driver appropriately about the information.

The determination module 19 obtains information as to the status of the car 500, such as the speed of it, and compares the current status of the car 500 with the information which has been read by the module 16 to determine whether the driver is breaking the traffic rules. If the driver is breaking the traffic rules, the informing module 18 informs the driver accordingly. For example, the identification module 15 may detect a traffic sign which warns that “the maximum speed is 60 kilometers per hour (km/h)”, and the determination module 19 obtains status-information that the speed of the car 500 is 80 km/h at present. In this situation, the informing module 18 informs the driver that the car 500 is speeding.

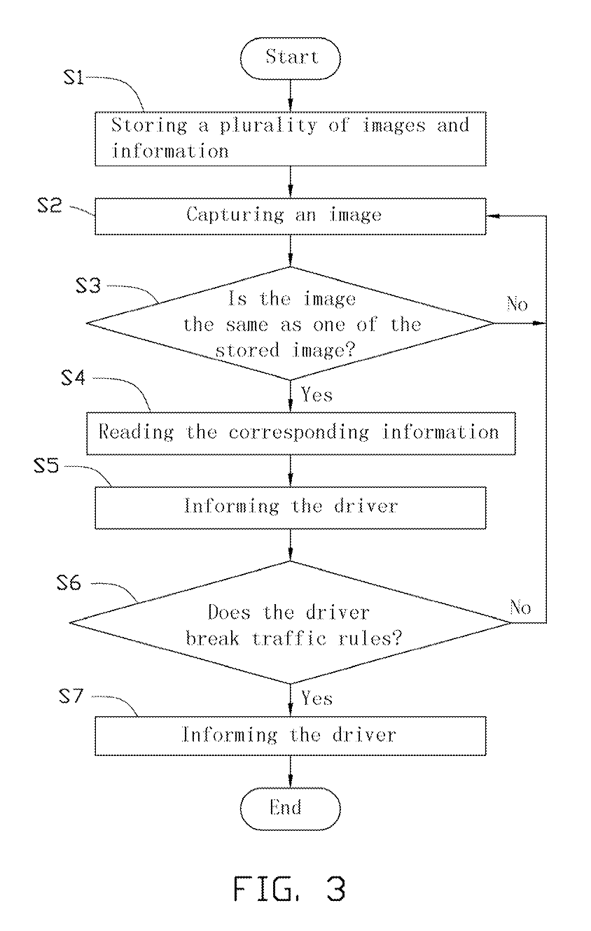

Referring to FIG. 3, an exemplary embodiment of a traffic sign informing method includes the following steps.

In step S1, a plurality of images of different traffic signs and the driver-information on each of them is stored in the image storing module 12.

In step S2, the camera 18 captures an image in front of the car 500.

In step S3, the identification module 15 compares the image obtained by the camera 10 with the stored images to determine whether or not there is a traffic sign in the image. If there is a traffic sign in the image, the process flows to step S4. If there is no traffic sign in the image, the process returns to step S2.

In the embodiment, the identification module 15 compares the image captured by the camera 10 with the images stored in the image storing module 12. If any part of the captured image is substantially the same as one of the stored images, it is determined that there is a traffic sign in the captured image.

In step S4, the reading module 16 reads the driver-information on the traffic sign.

In step S5, the informing module 18 informs the driver concerning the traffic sign.

In step S6, the determination module 19 obtains information as to the status of the car 500, such as the speed of the car 500, and compares the status of the car 500 with the information read by the module 16 to determine if the driver is breaking the traffic rules. If the driver is breaking the traffic rules, the procedure flows to step S7. If the driver is not breaking the traffic rules, the procedure returns to step S2.

In step S7, the informing module 18 informs the driver that the car is not following the traffic rules.

The foregoing description of the exemplary embodiments of the disclosure has been presented only for the purposes of illustration and description and is not intended to be exhaustive or to limit the disclosure to the forms disclosed. Many modifications and variations are possible. The embodiments have been chosen and described in order to explain the principles of the disclosure and their practical application so as to enable others of ordinary skill in the art to utilize the disclosure in various embodiments, and with such various modifications as are suited to the particular use contemplated. Alternative embodiments will become apparent to those of ordinary skill in the art to which the present disclosure pertains without departing from its spirit and scope.

Accordingly, the scope of the present disclosure is defined by the appended claims rather than by the foregoing description and the exemplary embodiments described therein.

What is claimed is:

1. A traffic sign informing system comprising:
a camera to capture an image in front of a car;
a processing unit connected to the camera; and
a storage unit connected to the processing unit and storing a plurality of programs to be executed by the processing unit, wherein the storage unit comprises:
an identification module to detect the image captured by the camera to determine whether there is a traffic sign in the image;
a reading module to read corresponding information when there is a traffic sign in the image; and
an informing module to inform a driver about the traffic sign and the corresponding information.

2. The traffic sign informing system of claim 1, wherein the storage unit further comprises an image storing module, wherein the image storing module stores a plurality of images of different traffic signs, and the information corresponding to the traffic signs.

3. The traffic sign informing system of claim 1, wherein the storage unit further comprises a determination module, wherein the determination module obtains status of the car and compares the status of the car with the information corresponding to the traffic sign to determine whether the car is following the traffic rules, the informing module further informs the driver.

4. A traffic sign informing method comprising:
capturing an image in front of a car by a camera;
detecting the image captured by the camera to determine whether there is a traffic sign in the image;
reading corresponding information when there is a traffic sign in the image; and
informing the driver about the traffic sign and the corresponding information.

5. The traffic sign informing method of claim 4, wherein the step “detecting the image captured by the camera to determine whether there is a traffic sign in the image” comprises:
comparing the image captured by the camera with a plurality of images, if the image is the same as one of the plurality of images, a determination is made that there is a traffic sign in the image.

6. The traffic sign informing method of claim 4, further comprising:
obtaining status of the car and comparing the status of the car with the information corresponding to the traffic sign to determine whether the car is following the traffic rules when there is a traffic sign in the image; and
informing the driver if the car is not following the traffic rules.
